(19) United States
(12) Patent Application Publication
(10) Pub. No.: US 2024/0220276 A1
(43) Pub. Date: Jul. 4, 2024

(54) APPARATUS, SYSTEM, AND METHOD OF PROXIMITY DETECTION

(71) Applicant: INTEL CORPORATION, SANTA CLARA, CA (US)

(72) Inventors: Atsuo Kuwahara, Camas, WA (US); Prasanna Desai, Elfin Forest, CA (US); Kannan Raja, Beaverton, OR (US)

(73) Assignee: INTEL CORPORATION, SANTA CLARA, CA (US)

(21) Appl. No.: 18/090,269

(22) Filed: Dec. 28, 2022

(51) Int. Cl. G06F 9/4401; G06F 1/3231; H04W 52/02

(52) U.S. Cl. CPC G06F 9/4418; G06F 1/3231; H04W 52/0229; H04W 52/0254

(57) ABSTRACT

For example, a display device may be configured to detect a proximity event based on Bluetooth (BT) signals communicated between a BT radio of the display device and a peripheral BT device. For example, the proximity event may indicate proximity of the peripheral BT device to the display device. For example, the display device may be configured to, based on the proximity event, send a proximity-based trigger signal to a computing device via a communication link between the display device and the computing device. For example, the proximity-based trigger signal may be configured to trigger a proximity-based change of an operational state of the computing device.

### TECHNICAL FIELD

Aspects described herein generally relate to proximity detection.

### BACKGROUND

A computing device, e.g., a laptop or a desktop, may be configured to be aware of its surrounding, for example, to perform one or more proximity-based tasks, for example, based on a detection of changes in an environment of the computing device.

In one example, the one or more proximity-based tasks may include waking up the computing device from a power save mode, for example, when a user is approaching the computing device.

In another example, the one or more proximity-based tasks may include connecting the computing device to a peripheral device, e.g., a mouse or a headset, for example, when the peripheral device is in close proximity to the computing device.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a proximity-based detection scheme, in accordance with some demonstrative aspects.

FIG. 3 is a schematic flow-chart illustration of a method of waking up a computing device, in accordance with some demonstrative aspects.

FIG. 4 is a schematic illustration of a proximity-based connection scheme to connect a peripheral Bluetooth device to a computing device, in accordance with some demonstrative aspects.

FIG. 5 is a schematic flow-chart illustration of a method of proximity detection, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Bluetooth (BT) device, a Bluetooth Low Energy (BLE) device, an audio device, a video device, an audio (A/V) device, a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing Bluetooth standards (“the Bluetooth standards”), e.g., including Bluetooth Core Specification V5.3, Jul. 13, 2021, and/or future versions and/or derivatives thereof, devices and/or networks operating in accordance with existing IEEE 802.11 standards (including IEEE 802.11-2020 (IEEE 802.11-2020, IEEE Standard for Information Technology-Telecommunications and Information Exchange between Systems Local and Metropolitan Area Networks-Specific Requirements; Part 11: Wireless LAN Medium Access Control (MAC) and Physical Layer (PHY) Specifications, December, 2020)) and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, a Bluetooth system, a BLE system, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), Extended GPRS, Code-Division Multiple Access (CDMA), Wideband CDMA (WCDMA), CDMA 2000, single-carrier CDMA, multi-carrier CDMA, Multi-Carrier Modulation (MCM), Discrete Multi-Tone (DMT), Bluetooth®, Global Positioning System (GPS), Wi-Fi, Wi-Max, ZigBee™ Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE Advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a frequency band of 2.4 GHz, 5 GHz, or 6 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects are described herein with respect to BT communication, e.g., according to a BT protocol and/or a BLE protocol. However, other aspects may be implemented with respect to any other communication scheme, network, standard and/or protocol.

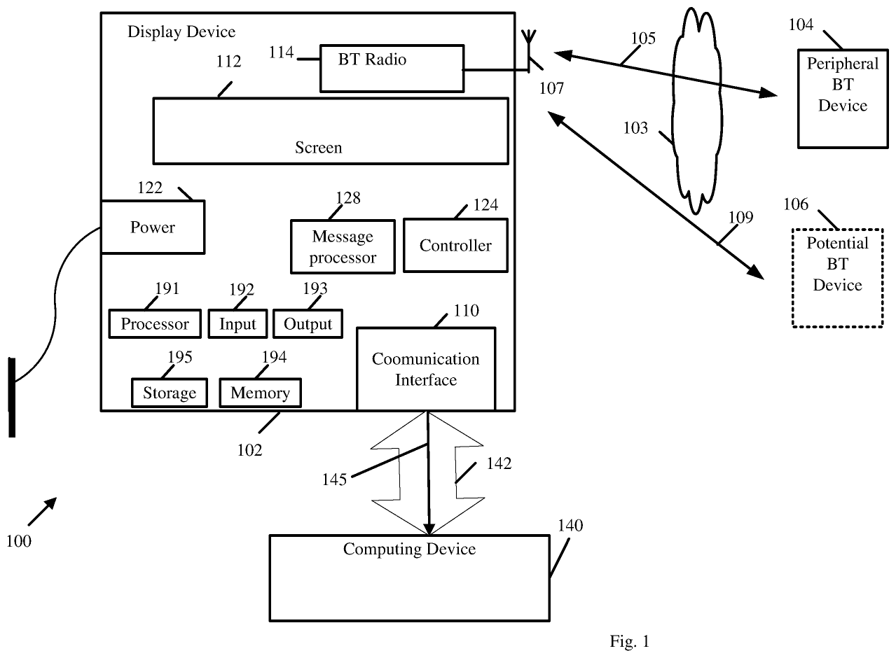

Reference is now made to FIG. 1, which schematically illustrates a block diagram of a system 100, in accordance with some demonstrative aspects.

As shown in FIG. 1, in some demonstrative aspects, system 100 may include a display device 102 and a computing device 140, e.g., as described below.

In some demonstrative aspects, display device 102 may be configured to display content, for example, from computing device 140.

In one example, display device 102 may be configured to display videos, photos, documents, and/or the like, from computing device 140.

In another example, display device 102 may be configured to display online videos, webpages, Internet content, and/or the like, for example, which may be downloaded by computing device 140.

In some demonstrative aspects, computing device 140 may include a laptop computer, a desktop computer, or any other computing device, e.g., as described below.

In some demonstrative aspects, computing device 140 may include, for example, a PC, a mobile computer, an Ultrabook™ computer, a notebook computer, a tablet computer, a server computer, a handheld computer, a mobile or portable device, a non-mobile or non-portable device, a video device, an audio device, or the like.

In some demonstrative aspects, the display device 140 may include a screen 112. For example, screen 112 may include a Light Emitting Diode (LED) screen, an Organic LED (OLED) screen, a Liquid Crystal Display (LCD) screen, or the like.

In some demonstrative aspects, display device 102 may include a power input 122, which may be configured to provide power to operate display device 102.

In some demonstrative aspects, power input 122 may be connected to a mains power, for example, via a power cord to a power socket in a wall.

In some demonstrative aspects, display device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of device 102 may be enclosed in a common housing or packaging, and may be interconnected or operably associated using one or more wired or wireless links. In other aspects, components of display device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of display device 102 and/or of one or more suitable applications.

In some demonstrative aspects, input unit 192 may include, for example, operating buttons, touch buttons, a keypad, a touch-screen, a stylus, a microphone, or any other suitable pointing device or input device. Output unit 193 includes, for example, one or more indicators, e.g., an on/off light indication, one or more audio speakers or earphones, and/or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a Solid State Drive (SSD), or other suitable removable or non-removable storage units. Memory unit 194 and/or storage unit 195, for example, may store data processed by display device 102.

In some demonstrative aspects, display device 102 may include a communication interface 110 configured to communicate with computing device 140, for example, via a communication link 142, e.g., as described below.

In some demonstrative aspects, communication link 142 may include a wired or a physical link between display device 102 and computing device 140. For example, communication link 142 may include a Universal Serial Bus (USB) link, a High Definition Multimedia Interface (HDMI) link, a Thunderbolt link, or the like,

In some demonstrative aspects, communication link 142 may include a wireless communication link between display device 102 and computing device 140. For example, communication link 142 may include a wireless display link, a Miracast link, a P2P link, a WiFi link, a BT link, or the like.

In some demonstrative aspects, display device 102 may be capable of communicating content, data, information, and/or signals via a wireless medium (WM) 103.

In some demonstrative aspects, wireless medium 103 may include, for example, a BT channel, a BLE channel, a radio channel, a wireless communication channel, a cellular channel, a Global Navigation Satellite System (GNSS) Channel, an RF channel, a WiFi channel, an IR channel, and the like.

In some demonstrative aspects, wireless communication medium 103 may include a 2.4 GHz frequency band, and/or one or more other wireless communication frequency bands, for example, a 5 GHz frequency band, a 6 GHz frequency band, a millimeterWave (mmWave) frequency band, e.g., a 60 GHz frequency band, a Sub-1 GHz (S1G) band, and/or any other frequency band.

In some demonstrative aspects, display device 102 may include one or more radios including circuitry and/or logic to perform wireless communication between device 102, and one or more other devices. For example, device 102 may include at least one BT radio 114.

In some demonstrative aspects, display device 102 may include one or more other radios, e.g., a WiFi radio, an OFDM radio, a cellular radio, and/or the like.

In some demonstrative aspects, BT radio 114 may include one or more wireless receivers (Rx) including circuitry and/or logic to receive wireless communication signals, RF signals, BT signals, frames, blocks, transmission streams, packets, messages, data items, and/or data.

In some demonstrative aspects, BT radio 114 may include one or more wireless transmitters (Tx) including circuitry and/or logic to transmit wireless communication signals, RF signals, BT signals, frames, blocks, transmission streams, packets, messages, data items, and/or data.

In some demonstrative aspects, BT radio 114 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, BT radio 114 may be configured to communicate over a 2.4 GHz band, and/or any other band.

In some demonstrative aspects, BT radio 114 may include, or may be associated with, one or more antennas. For example, BT radio 114 may include, or may be associated with, one or more antennas 107.

In one example, display device 102 may include a single antenna 107. In another example, device 102 may include two or more antennas 107.

In some demonstrative aspects, antennas 107 may include any type of antennas suitable for transmitting and/or receiving wireless communication signals, blocks, frames, transmission streams, packets, messages and/or data. For example, antennas 107 may include any suitable configuration, structure, and/or arrangement of one or more antenna elements, components, units, assemblies, and/or arrays. In some aspects, antennas 107 may implement transmit and receive functionalities using separate transmit and receive antenna elements. In some aspects, antennas 107 may implement transmit and receive functionalities using common and/or integrated transmit/receive elements.

In some demonstrative aspects, display device 102 may include a controller 124 configured to perform and/or to trigger, cause, instruct and/or control display device 102 to perform, one or more communications, to generate and/or communicate one or more messages and/or transmissions, and/or to perform one or more functionalities, operations and/or procedures between display device 102 and one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In one example, controller 124 may include circuitry and/or logic, for example, one or more processors including circuitry and/or logic, to cause, trigger and/or control a display device, e.g., display device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, controller 124 may be configured to include and/or perform one or more functionalities and/or operations of a BT controller of the display device 102.

In some demonstrative aspects, one or more functionalities and/or operations of controller 124 may be implemented as part of a host processor of the display device 102.

In some demonstrative aspects, at least part of the functionality of controller 124 may be implemented as part of one or more elements of radio 114.

In other aspects, the functionality of controller 124 may be implemented as part of any other element of display device 102.

In some demonstrative aspects, display device 102 may include a message processor 128 configured to generate, process and/or access one or more messages communicated by display device 102.

In one example, message processor 128 may be configured to generate one or more messages to be transmitted by display device 102, and/or message processor 128 may be configured to access and/or to process one or more messages received by display device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), e.g., a PHY Layer Convergence Procedure (PLCP) PDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, message processor 128 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processor 128, respectively. Additionally or alternatively, one or more functionalities of message processor 128 may be implemented by logic, which may be executed by a machine and/or one or more processors, e.g., as described below.

In some demonstrative aspects, at least part of the functionality of message processor 128 may be implemented as part of radio 114.

In some demonstrative aspects, at least part of the functionality of message processor 128 may be implemented as part of controller 124.

In other aspects, the functionality of message processor 128 may be implemented as part of any other element of display device 102.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of display device 102.

In some demonstrative aspects, for example, in some use cases, scenarios, deployments, and/or implementations, there may be a need to provide a technical solution to support detection of a proximity of a peripheral BT device 104 to the computing device 140, e.g., as described below.

In some demonstrative aspects, the peripheral BT device 104 may include a Smartphone, a Mobile phone, a mouse, a keyboard, a headset, earphones, a remote control, a peripheral device belonging to a user of the computing device 140, and/or the like.

In one example, there may be a need to provide a technical solution to support an awareness capability of a client system, e.g., a desktop, a laptop, and/or any other computing device, to be more aware of its surrounding and/or environment.

In one example, there may be a need to provide a technical solution to support the client system to perform one or more tasks, for example, based on detection of changes in the surrounding and/or environment of the client system.

In one example, a detected proximity of the peripheral BT device 104 to the computing device 140 may indicate that a user is approaching the computing device 140.

In another example, a detected proximity of the peripheral BT device 104 to the computing device 140 may indicate that the peripheral BT device 104, e.g., a mouse, is in close proximity to the computing device 140, for example, a proximity suitable to trigger a connection between the computing device 140 and the peripheral BT device 104.

In some demonstrative aspects, there may be a need to provide a technical solution to support triggering of one or more proximity-based operations, for example, based on detection of the proximity of the peripheral BT device 104 to the computing device 140, e.g., as described below.

In some demonstrative aspects, the one or proximity-based operations may include switching a mode of operation of the computing device 140 based on the proximity detection, e.g., as described below.

In one example, the one or proximity-based operations may include waking up the computing device 140 from a power save mode, for example, when a user and/or a peripheral device of the user is approaching the computing device 140, e.g., as described below.

In another example, the one or proximity-based operations may include switching the computing device 140 to the power save mode, for example, when the user and/or the peripheral device of the user is moving away from the computing device 140, e.g., as described below.

In some demonstrative aspects, the one or proximity-based operations may include configuring a connection between the computing device 140 and the peripheral BT device 104 based on the proximity detection, e.g., as described below.

In one example, the one or more proximity-based operations may include connecting, e.g., automatically connecting, the computing device 140 to the peripheral device 104, e.g., a mouse or a headset, for example, when detecting that the peripheral device is moved close to the computing device 140, e.g., when the peripheral device 104 is moved within a close range to the computing device 140.

In another example, the one or more proximity-based operations may include disconnecting, e.g., automatically disconnecting, the computing device 140 from the peripheral device 104, for example, when the peripheral device 104 is moved away from the computing device 140, e.g., when the peripheral device 104 is move to a far range from the computing device 140.

In some demonstrative aspects, for example, in some use cases, scenarios, and/or implementations, there may be one or more disadvantages, inefficiencies, and/or technical problems in implementations based on image sensors and/or dedicated proximity sensors, for example, to detect proximity of a peripheral device to the computing device 140. For example, these implementations may not be sufficient to accurately detect the peripheral device, e.g., when approaching the computing device 140.

In some demonstrative aspects, for example, in some use cases, scenarios, and/or implementations, there may be one or more disadvantages, inefficiencies, and/or technical problems in implementations based on the dedicated proximity sensors, for example, to detect proximity of the peripheral device, e.g., as described below.

In one example, the dedicated proximity sensors may not be capable of supporting recognition of an approaching peripheral device. For example, even though dedicated proximity sensors may detect something is approaching the computing device, these dedicated proximity sensors may not be able to identify or understand exactly what is approaching.

In some demonstrative aspects, for example, in some use cases, scenarios, and/or implementations, there may be one or more disadvantages, inefficiencies, and/or technical problems in implementations based on imaging sensors, for example, to detect proximity of a peripheral device to the computing device 140. For example, the imaging sensors may include Red-Green-Blue (RGB) cameras, Infra-Red (IR) cameras, or the like. These imaging sensors may support a client system in further running classification algorithms to determine and/or to identify what is approaching, such as a person, a person holding laptop, or the like.

In one example, although the imaging sensors may allow further processing of images, e.g., to classify, identify, and/or recognize objects captured by the imaging sensors, the imaging sensors may not be able to capture objects that are hidden from the view of the imaging sensors. For example, a mouse that may be held in the hand of a person approaching the computing device 140 may not be captured and/or identified by the imaging sensor.

In another example, the imaging sensor may not be capable of supporting an accurate estimation of a distance of the detected object. For example, the imaging sensor may not be capable of supporting an accurate estimation of a distance of a Smartphone based on a detected size of the Smartphone, for example, as Smartphones may be manufactured in a variety of sizes and shapes.

In another example, the imaging sensor may have a relatively high power consumption, for example, compared to the power consumption of a BLE device.

In some demonstrative aspects, for example, in some use cases, scenarios, and/or implementations, there may be one or more disadvantages, inefficiencies, and/or technical problems in implementations based on BT beacons, for example, to detect proximity of peripheral devices to the computing device 140. For example, BT beacons may be implemented to track user locations in some environments, In one example, BT beacons may be placed in several locations per isle in a store, for example, to track a Smartphone or other Bluetooth devices a shopper is carrying. However, implementations using BT beacons for proximity detection may require placing dedicated BT beacons throughout an environment. For example, a very large number of BT beacons may be required to be placed in the environment to track a user location. For example, a location detection based on the BT beacons may not be capable of supporting an accurate detection. For example, an accuracy of a Received Signal Strength Indication (RSSI) proximity measurement based on BT LE beacons may be very poor. For example, this poor accuracy of the RSSI measurement may be due to presence of 20-30 dB fading nulls, for example, across an 80 MHz Bluetooth frequency band.

In some demonstrative aspects, display device 102 may be configured to provide a technical solution to support proximity detection utilizing an integrated BT module, e.g., including BT radio 114 and controller 124, which may be integrated within display device 102, e.g., as described below.

In some demonstrative aspects, display device 102 may be configured to implement a BT-based proximity detection mechanism, which may be configured perform BT-based proximity detection at display device 102, for example, to trigger one or more proximity-based operations for computing device 140, e.g., as described below.

In some demonstrative aspects, the BT module, e.g., BT radio 114 and controller 124, may be integrated in display device 102, for example, to provide a technical solution to support enhanced user experience.

In one example, integrating the BT module within display device 102 may provide a technical solution to support a user to control and/or perform one or more operations to control display device 102, for example, via a peripheral BT device. For example, display device 102 may allow the user to adjust monitor color, brightness and/or other settings of screen 112, for example, via a BT peripheral device, e.g., a BT enabled mouse, or other device.

In some demonstrative aspects, display device 102 may be configured to implemented the BT-based proximity detection mechanism to provide a technical solution to support an “always sensing” and/or an intelligent sensing and device connection, for example, of peripheral BT devices, e.g., as described below.

In some demonstrative aspects, utilizing the BT module integrated within display device 102 for proximity detection may provide a technical advantage in terms of power consumption and/or power management, for example, as display device 102 may wall-powered, e.g., via power input 122. In one example, power management of display device 102 may be optimized, for example, such that power-hungry components, e.g., a backlight of screen 112, may be turned off, for example, when display device 102 is in a low power mode. For example, the BT module may be operated, for example, to actively sense and track surrounding peripheral Bluetooth devices, e.g., even while display 102 is at the low power mode. For example, display device 102 may be configured to perform BT-based proximity detection, while allowing adjustments in aggressiveness of scanning and/or tracking distances. For example, display device 102 may be capable of supporting a relatively aggressive BT scanning profile, as display device 102 may wall-powered, e.g., via power input 122.

In some demonstrative aspects, utilizing the BT module integrated within display device 102 for proximity detection may provide a technical advantage in terms of efficient proximity sensing, for example, as display device 102 may be typically well placed for proximity sensing in an environment. For example, it may be assumed that a user will be sitting in front of the monitor 112 of the display device 102. Accordingly, the BT radio 114 may be utilized to detect movement of the user in an area in front of the monitor 112, e.g., as described below.

In some demonstrative aspects, display device 102 may be configured to perform BT-based proximity detection, for example, based on a High Accuracy Distance Measurement (HADM) technique, e.g., as described below.

In some demonstrative aspects, display device 102 may be configured to utilize the HADM technique to provide a technical solution to support an accurate estimation of the location and/or distance of peripheral BT devices with respect to display device 102, e.g., as described below.

In other aspects, display device 102 may be configured to utilize any other additional or alternative distance BT-based measurement and/or proximity detection mechanism.

In one example, the HADM technique may be implemented as a standardized Bluetooth feature, which may be configured to support estimation of a distance of a BT device, for example, with an accuracy of about 30 centimeters (cm) or any other level of accuracy.

In another example, display device 102 may be configured to utilize the HADM technique in conjunction with an Angle of Arrival (AoA) mechanism, e.g., a standardized Bluetooth AoA capability, for example, to support determining a direction from which a peripheral BT device is approaching display device 102.

In some demonstrative aspects, display device 102 may be configured to implement the combination of the HADM and the BT AoA, for example, to achieve an accurate ranging with an approaching-direction capability, e.g., as described below.

In some demonstrative aspects, display device 102 may be configured to determine one or more actions, e.g., a set of actions, to be triggered for the computing device 140, for example, based on distance information and AoA information, which may be determined based on BT signals communicated by BT radio 114, e.g., as described below.

In some demonstrative aspects, display device 102 may be configured to utilize BT-based distance measurement features, e.g., the HADM technique, for example, to provide a technical solution to accurately measure how far away peripheral BT devices or systems are from the monitor 112, e.g., as described below.

In some demonstrative aspects, display device 102 may be configured to utilize a plurality of BT-based measurements, e.g., HADMs and/or sensor fusion, for example, to determine a precise location of certain peripheral devices, for example, via triangulation. In one example, antennas 107 may be located at one or more corners, e.g., several corners, of display device 102, for example, to support increased accuracy of distance measurements, e.g., via triangulation.

In some demonstrative aspects, display device 102 may be configured to utilize BT communications by the integrated BT module within display device 102, for example, to provide a technical solution to support “always sensing” for peripheral devices, for example, even when display device is at the power save mode, and/or when computing device 140 as at a power save mode, e.g., as described below. This capability to support “always sensing” for peripheral devices may provide a technical solution to support enhanced user experience, e.g., better than other proximity-detections implementations.

In some demonstrative aspects, controller 124 may be configured to cause, trigger, instruct and/or control the display device 102 to detect a proximity event based on BT signals 105 communicated between the BT radio 114 of the display device 102 and a peripheral BT device 104, e.g., as described below.

In some demonstrative aspects, the proximity event may correspond to, e.g., indicate and/or represent, a proximity of the peripheral BT device 104 and the display device 102, e.g., as described below.

In some demonstrative aspects, controller 124 may be configured to cause, trigger, instruct and/or control the display device 102 to send a proximity-based trigger signal 145 to the computing device 140 via the communication link 142 between the display device 102 and the computing device 140, for example, based on the proximity event, e.g., as described below.

In some demonstrative aspects, the proximity-based trigger signal 145 may be configured to cause, e.g., trigger, a proximity-based change of an operational state of the computing device 140, e.g., as described below.

In some demonstrative aspects, the proximity-based change of the operational state of the computing device 140 may include a change of a power state of the computing device 140, e.g., as described below.

In some demonstrative aspects, the proximity-based change of the operational state of the computing device 140 may include a change of a locking state of the computing device 140, e.g., as described below.

In some demonstrative aspects, the proximity-based change of the operational state of the computing device 140 may include a change of a peripheral-connection state of a connection between the computing device 140 and the peripheral BT device 104, e.g., as described below.

In other aspects, proximity-based trigger signal 145 may be configured to trigger any other additional or alternative change in any other type of operational state of the computing device 140.

In some demonstrative aspects, the proximity event may include a user approach detection corresponding to, e.g., to indicate and/or represent, a detected approach of a user to the display device 102, e.g., as described below.

In some demonstrative aspects, the proximity-based trigger signal 145 may include a wakeup signal to cause, e.g., trigger, the computing device 140 to wake up from a power save state, for example, when the proximity event includes the user approach detection, e.g., as described below.

In some demonstrative aspects, the proximity-based trigger signal 145 may include an unlock signal to cause, e.g., trigger, unlocking of the computing device 140 from a locked state to an unlocked state, for example, when the proximity event includes the user approach detection, e.g., as described below.

In some demonstrative aspects, the proximity-based trigger signal 145 may include peripheral-connection trigger signal to cause, e.g., trigger, the computing device 140 to connect with the peripheral BT device 104 via the display device 102, for example, when the proximity event includes the user approach detection, e.g., as described below.

In some demonstrative aspects, the proximity event may include a user move-away detection corresponding to, e.g., to indicate and/or represent, a detection of a user moving away from the display device 102, e.g., as described below.

In some demonstrative aspects, the proximity-based trigger signal 145 may include a power save signal to cause, e.g., trigger, the computing device 140 to switch to a power save state, for example, when the proximity event includes the user move-away detection, e.g., as described below.

In some demonstrative aspects, the proximity-based trigger signal 145 may include a lock signal to cause, e.g., trigger, the computing device 140 to switch from an unlocked state to a locked state, for example, when the proximity event includes the user move-away detection, e.g., as described below.

In some demonstrative aspects, the proximity-based trigger signal 145 may include peripheral-disconnection trigger signal to cause, e.g., trigger, the computing device 140 to disconnect from the peripheral BT device 104, for example, when the proximity event includes the user move-away detection, e.g., as described below.

In some demonstrative aspects, controller 124 may be configured to cause, trigger, instruct and/or control the display device 102 to detect the proximity event according to an AoA measurement based on the BT signals 105, e.g., as described below.

In some demonstrative aspects, controller 124 may be configured to cause, trigger, instruct and/or control the display device 102 to detect the proximity event according to an Angle of Departure (AoD) measurement based on the BT signals 105, e.g., as described below.

In some demonstrative aspects, controller 124 may be configured to cause, trigger, instruct and/or control the display device 102 to detect the proximity event according to a Carrier Sensing (CS) measurement based on the BT signals 105, e.g., as described below.

In some demonstrative aspects, controller 124 may be configured to cause, trigger, instruct and/or control the display device 102 to detect the proximity event according to a HADM based on the BT signals 105, e.g., as described below.

In other aspects, controller 124 may be configured to cause, trigger, instruct and/or control the display device 102 to detect the proximity event according to any other additional and/or alternative proximity-detection mechanism, method, technique, and/or algorithm.

In some demonstrative aspects, controller 124 may be configured to cause, trigger, instruct and/or control the display device 102 to detect the proximity event, for example, based on a determination that the BT signals 105 are communicated with the BT peripheral device 104 in an area in front of a screen 112 of the display device 102, e.g., as described below.

In other aspects, controller 124 may be configured to cause, trigger, instruct and/or control the display device 102 to detect the proximity event, for example, based on BT signals communicated with the BT peripheral device 104 in any other additional area and/or location.

In some demonstrative aspects, controller 124 may be configured to cause, trigger, instruct and/or control the display device 102 to perform a BT proximity search to detect a potential BT device 106, e.g., as described below.

In some demonstrative aspects, controller 124 may be configured to cause, trigger, instruct and/or control the display device 102 to determine whether the potential BT device 106 is to be identified as a recognized BT device, which is designated for detection of the proximity event with respect to the computing device 140, e.g., as described below.

In some demonstrative aspects, controller 124 may be configured to cause, trigger, instruct and/or control the display device 102 to detect the proximity event based on an estimated location of the recognized BT device relative to the display device 102, for example, based on a determination that the detected BT device 106 is to be identified as the recognized BT device, e.g., as described below.

In some demonstrative aspects, the estimated location of the recognized BT device relative to the display device 102 may be based on BT signals 109 communicated between the display device 102 and the recognized BT device, e.g., as described below.

In some demonstrative aspects, controller 124 may be configured to cause, trigger, instruct and/or control the display device 102 to perform the BT proximity search in an area in front of the screen 112 of the display device 102, e.g., as described below.

In some demonstrative aspects, controller 124 may be configured to cause the display device 102 to perform the BT proximity search in any other additional or alternative area, e.g., other than the area in front of screen 112.

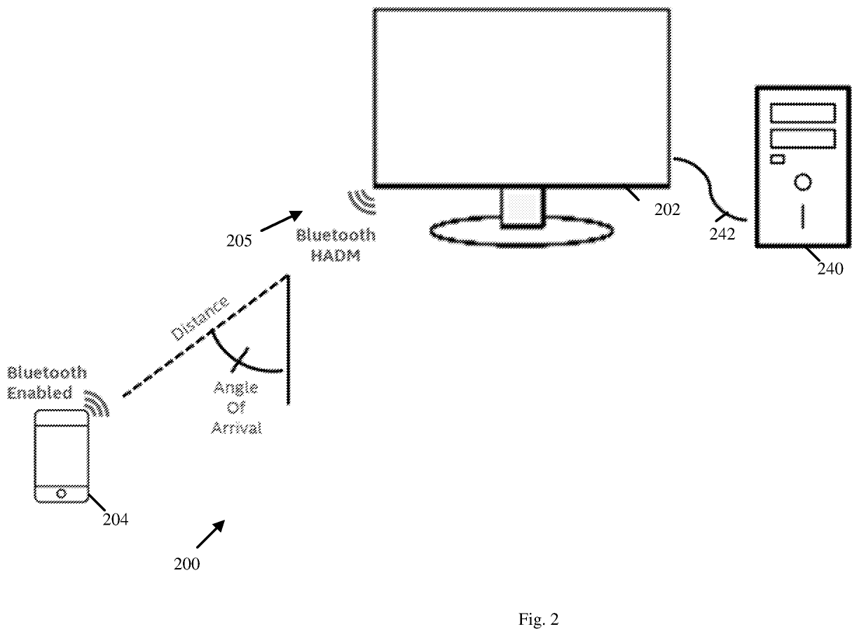

Reference is made to FIG. 2, which schematically illustrates a proximity-based detection scheme 200, in accordance with some demonstrative aspects.

In some demonstrative aspects, as shown in FIG. 2, a computing device 240 may be connected to a display device 202, for example, via a communication link 242, e.g., a wired link. For example, display device 102 (FIG. 1) may implement one or more elements of display device 202, and/or may perform one or more operations and/or functionalities of display device 202.

In some demonstrative aspects, as shown in FIG. 2, display device 202 may be configured to detect proximity of BT peripheral devices, for example, according to an HADM technique, e.g., based on BT signals 205 communicated by display device 202.

In some demonstrative aspects, as shown in FIG. 2, proximity-based detection scheme 200 may demonstrate a use case, in which a person carrying a Smartphone 204 is approaching a desktop system, e.g., including computing device 240. For example, the person may be a user of the computing device 240.

In some demonstrative aspects, a controller of display device 202, e.g., controller 124 (FIG. 1), may be configured to cause display device 202 to detect a proximity event based on BT signals 205 communicated between a BT radio of the display device 202, e.g., BT radio 114 (FIG. 1), and the Smartphone 204. For example, the proximity event may correspond to, e.g., indicate and/or represent, a proximity of the Smartphone 204 to the display device 202.

In some demonstrative aspects, the controller of display device 202, e.g., controller 124 (FIG. 1), may be configured to cause display device 202 to send a proximity-based trigger signal to the computing device 240, e.g., based on the detected proximity event.

For example, display device 202 may send the proximity-based trigger signal via the communication link 242 between the display device 202 and the computing device 240.

In some demonstrative aspects, the proximity-based trigger signal may include a wakeup signal to cause, e.g., trigger, the computing device 240 to wake up from a power save state. For example, display device 202 may be configured to send the wakeup signal to computing device 240, for example, based on detection of a proximity event representing a user approach detection to indicate a detected approach of a user of the Smartphone 204 to the display device 202, e.g., as described below.

In some demonstrative aspects, the controller of display device 202, e.g., controller 124 (FIG. 1), may be configured to cause display device 202 to perform a BT proximity search to detect a potential BT device, e.g., the Smartphone 204.

In some demonstrative aspects, the controller of display device 202, e.g., controller 124 (FIG. 1), may be configured to determine whether the potential BT device is to be identified as a recognized BT device, which is designated for detection of the proximity event with respect to the computing device 240.

In some demonstrative aspects, the user of the computing device 240 may designate one or more BT devices, which are to be designated for detection of the proximity event with respect to the computing device 240.

In some demonstrative aspects, the controller of display device 202, e.g., controller 124 (FIG. 1), may be configured to, e.g., based on a determination the detected BT device, e.g., Smartphone 204, is to be identified as the recognized BT device, detect the proximity event based on an estimated location of the recognized BT device, e.g., Smartphone 204, relative to the display device 202.

In some demonstrative aspects, the controller of display device 202, e.g., controller 124 (FIG. 1), may be configured to determine the estimated location of the Smartphone 204 relative to the display device 202, for example, based on the BT signals 205 communicated between the display device 202 and the Smartphone 204, e.g., as described above.

In some demonstrative aspects, the controller of display device 202, e.g., controller 124 (FIG. 1), may be configured to cause display device 202 to monitor the location of the Smartphone 204, for example, to detect a proximity event representing a user move-away detection to indicate a detection of the user of Smartphone 204 moving away from the display device 202.

In some demonstrative aspects, the controller of display device 202, e.g., controller 124 (FIG. 1), may be configured to cause display device 202 to send, e.g., via communication link 242, a power save signal and/or a lock signal to the computing device 240, e.g., based on the user move-away detection. For example, the power save signal may be configured to cause, e.g., trigger, the computing device 240 to switch to a power save state. For example, the lock signal may be configured to cause, e.g., trigger, the computing device 240 to switch from an unlocked state to a locked state.

In some demonstrative aspects, as shown in FIG. 2, display device 202 may be configured to detect that the Smartphone 204 is approaching the display device 202, for example, based on the BT signals 205.

In some demonstrative aspects, as shown in FIG. 2, display device 202 may be configured to wake up the computing device 240, for example, based on the detected proximity of the Smartphone 204.

In some demonstrative aspects, display device 202 may include a BT module, e.g., BT radio 114 (FIG. 1), which may be connected to compute capability, e.g., a Lid-Controller Hub, in display device 202. For example, controller 124 (FIG. 1) may include and/or may implement one or more functionalities of the compute capability.

In some demonstrative aspects, display device 202 may be configured to wake up the computing device 240 from a low-power state, for example, based on detection that the Smartphone 204 is approaching the display device 202.

In some demonstrative aspects, the communication link 242 between display device 202 and computing device 240 may be implemented by a connection, for example, via a USB-C connection or any other connection, which may have a wakeup capability, e.g., to trigger a wake up of computing device 240.

In some demonstrative aspects, as shown in FIG. 2, display device 202 may detect the proximity of the Smartphone to computing device 240, for example, according to an AoA measurement based on the BT signals 205, for example, to detect a direction of the location of the Smartphone 204 relative to display device 202, and/or according to an HADM technique based on the BT signals 205, for example, to estimate a distance of the Smartphone 204 from display device 202.

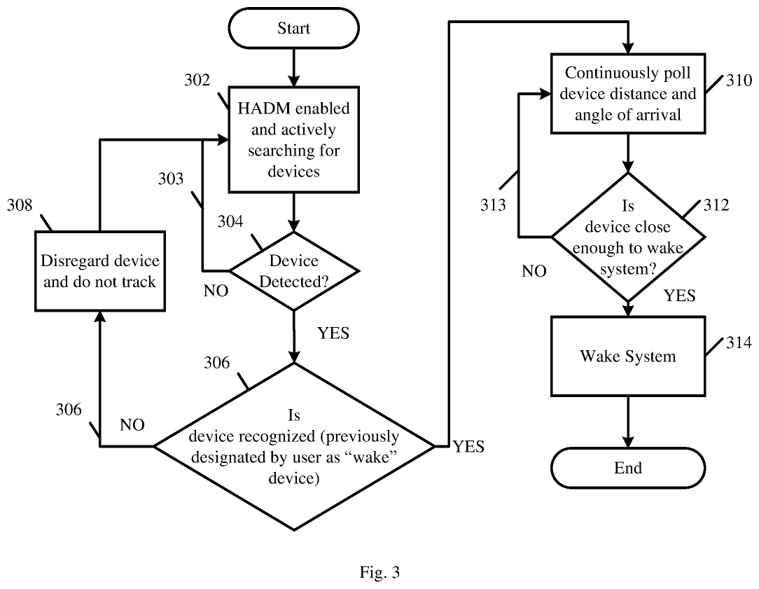

Reference is made to FIG. 3, which schematically illustrates a method of waking up a computing device, in accordance with some demonstrative aspects. For example, one or more operations of the method of FIG. 3, may be performed by one or more elements of a system, e.g., system 100 (FIG. 1), for example, a display device, e.g., display device 102 (FIG. 1), and/or a controller, e.g., controller 124 (FIG. 1).

In some demonstrative aspects, as indicated at block 302, the method may include performing a BT proximity search, e.g., according to an HADM technique, for example, to detect a potential BT device. For example, controller 124 (FIG. 1) may be configured to cause display device 102 (FIG. 1) to perform the BT proximity search based on the HADM technique, for example, to detect the potential BT device 106 (FIG. 1), e.g., as described above.

In some demonstrative aspects, as indicated at block 304, the method may include determining whether or not a potential BT device is detected based on the BT proximity search. For example, controller 124 (FIG. 1) may be configured to determine whether or not the potential BT device 106 (FIG. 1) is detected based on the BT proximity search, e.g., as described above.

In some demonstrative aspects, as indicated by arrow 303, the method may include continuing to perform the BT proximity search based on the HADM technique, for example, until a potential BT device is detected. For example, controller 124 (FIG. 1) may be configured to continue to perform the BT proximity search based on the HADM technique, for example, as an “always sensing” operation, e.g., as described above.

In some demonstrative aspects, as indicated at block 306, the method may include determining whether or not the detected potential BT device may be identified as a recognized BT device, for example, when a potential BT device is detected. For example, controller 124 (FIG. 1) may be configured to determine whether or not the potential BT device 106 (FIG. 1) may be identified as the recognized BT device, e.g., as described above.

In some demonstrative aspects, as indicated at block 308, the method may include disregarding the potential BT device and returning to perform the BT proximity search, for example, when the potential BT device is not identified as a recognized BT device. For example, controller 124 (FIG. 1) may be configured to disregard the potential BT device 106 (FIG. 1) and return to the BT proximity search, for example, when the potential BT device 106 (FIG. 1) is not identified as a recognized BT device, e.g., as described above.

In some demonstrative aspects, as indicated at block 310, the method may include estimating, e.g., continuously estimating, a location of the recognized BT device, for example, when the potential BT device is identified as a recognized BT device. For example, controller 124 (FIG. 1) may be configured to monitor the estimated location of the recognized BT device, e.g., as described above.

In one example, the location of the recognized BT device may be continuously monitored, for example, by repeatedly polling a device distance of the recognized BT device and an AOA of signals from the recognized BT device, e.g., as described above.

In some demonstrative aspects, as indicated at block 312, the method may include determining whether or not the location of the recognized BT device is close enough to the computing device, e.g., to trigger a proximity-based operation. For example, controller 124 (FIG. 1) may be configured to determine whether or not the location of the recognized BT device is close enough to the computing device 140 (FIG. 1), for example, to trigger a proximity-based operation, e.g., as described above.

In some demonstrative aspects, as indicated by arrow 313, the method may include monitoring, e.g., substantially continuously monitoring, the location of the recognized BT device, for example, as long as the location of the recognized BT device is not detected to be close enough to the computing device, e.g., closer than a proximity detection threshold. For example, controller 124 (FIG. 1) may be configured to substantially continuously monitor the location of the recognized BT device, for example, as long as the location of the recognized BT device is not close enough to the computing device 140 (FIG. 1), e.g., as described above.

In some demonstrative aspects, as indicated at block 314, the method may include waking up the computing device, for example, based on a determination that the location of the recognized BT device is close enough to the computing device. For example, controller 124 (FIG. 1) may be configured to wake up the recognized BT device, for example, by sending a wakeup trigger signal 145 (FIG. 1) to the computing device 140 (FIG. 1). For example, controller 124 (FIG. 1) may be configured to wake up the recognized BT device, for example, based on a determination that the location of the recognized BT device is within a predefined “wakeup” distance from the computing device 140 (FIG. 1), e.g., as described above.

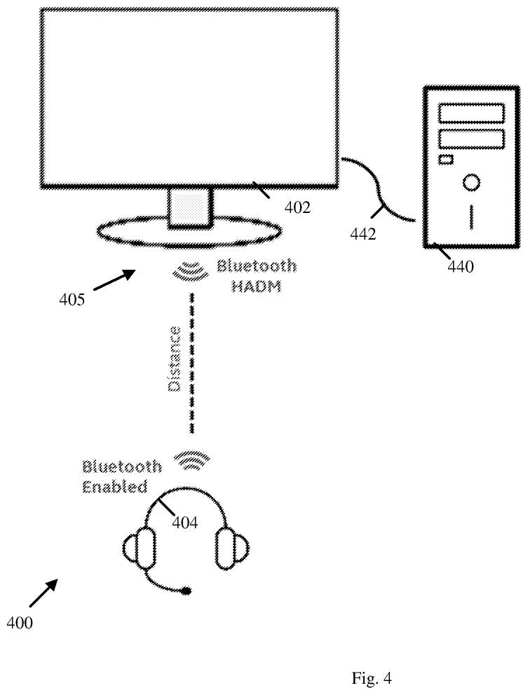

Reference is made to FIG. 4, which schematically illustrates a proximity-based connection scheme 400 to connect a peripheral BT device 404 to a computing device 440, in accordance with some demonstrative aspects.

In some demonstrative aspects, as shown in FIG. 4, computing device 440 may be connected to a display device 402, for example, via a communication link 442, e.g., a wired link. For example, display device 102 (FIG. 1) may implement one or more elements of display device 402, and/or may perform one or more operations and/or functionalities of display device 402.

In some demonstrative aspects, as shown in FIG. 4, peripheral BT device 404 may include a headset.

In other aspects, peripheral BT device 404 may include any other peripheral BT device, e.g., a mouse, a keyboard and/or the like.

In some demonstrative aspects, as shown in FIG. 4, display device 402 may be configured to detect proximity of BT peripheral devices, for example, according to an HADM technique, e.g., based on BT signals 405 communicated by display device 402.

In one example, as shown in FIG. 4, proximity-based connection scheme 400 may demonstrate a use case, in which peripheral BT device 404, for example, a headset, may be shared with a plurality of systems. According to this example, a user may take the peripheral BT device 404 from computing device 440 elsewhere, for example, for use with another device, e.g., a Smartphone or a TV. For example, upon returning to the computing device 440, the peripheral BT device 404 may be reconnected with the computing device 440, for example, to allow immediate use of the peripheral BT device 404 with the computing device 440.

In some demonstrative aspects, a controller of display device 402, e.g., controller 124 (FIG. 1), may be configured to cause display device 402 to detect a proximity event based on BT signals 405 communicated between a BT radio of the display device 402, e.g., BT radio 114 (FIG. 1), and the peripheral BT device 404. For example, the proximity event may correspond to, e.g., indicate and/or represent, a proximity of the peripheral BT device 404 to the display device 402.

In some demonstrative aspects, the controller of display device 402, e.g., controller 124 (FIG. 1), may be configured to cause display device 402 to send a proximity-based trigger signal to the computing device 440, e.g., based on the detected proximity event.

For example, display device 402 may send the proximity-based trigger signal via the communication link 442 between the display device 402 and the computing device 440.

In some demonstrative aspects, the proximity-based trigger signal may include a peripheral-connection trigger signal to cause, e.g., trigger, the computing device 440 to connect with the peripheral BT device 404 via the display device 402. For example, display device 402 may be configured to send the peripheral-connection trigger signal to computing device 440, for example, based on detection of a proximity event representing a user approach detection to indicate a detected approach of peripheral BT device 404 to the display device 402, e.g., as described below.

In some demonstrative aspects, the controller of display device 402, e.g., controller 124 (FIG. 1), may be configured to cause display device 402 to perform a BT proximity search to detect a potential BT device, e.g., the peripheral BT device 404.

In some demonstrative aspects, the controller of display device 402, e.g., controller 124 (FIG. 1), may be configured to determine whether the potential BT device is to be identified as a recognized BT device, which is designated for detection of the proximity event with respect to the computing device 440.

In some demonstrative aspects, the user of the computing device 440 may designate one or more peripheral BT devices, e.g., a headset, a mouse, or the like, which are to be designated for automatically connecting with the computing device 440.

In some demonstrative aspects, the controller of display device 402, e.g., controller 124 (FIG. 1), may be configured to, e.g., based on a determination the detected BT device, e.g., peripheral BT device 404, is to be identified as the recognized BT device, detect the proximity event based on an estimated location of the recognized BT device, e.g., peripheral BT device 404, relative to the display device 402.

In some demonstrative aspects, the controller of display device 402, e.g., controller 124 (FIG. 1), may be configured to determine the estimated location of the peripheral BT device 404 relative to the display device 402, for example, based on the BT signals 405 communicated between the display device 402 and the peripheral BT device 404, e.g., as described above.

In some demonstrative aspects, the controller of display device 402, e.g., controller 124 (FIG. 1), may be configured to cause display device 402 to monitor the location of the peripheral BT device 404, for example, to detect a proximity event representing a user move-away detection to indicate a detection of the peripheral BT device 404 moving away from the display device 402.

In some demonstrative aspects, the controller of display device 402, e.g., controller 124 (FIG. 1), may be configured to cause display device 402 to send, e.g., via communication link 442, a peripheral-disconnection trigger signal to the computing device 440, e.g., based on the user move-away detection. For example, the peripheral-disconnection trigger signal may be configured to trigger the computing device 440 to disconnect from the peripheral BT device 404.

In some demonstrative aspects, as shown in FIG. 4, display device 402 may be configured to detect that the peripheral BT device 404 is approaching the display device 402, for example, based on the BT signals 405.

In some demonstrative aspects, display device 402 may be configured to search and track recognized peripheral BT devices, e.g., peripheral BT device 404, which have already been connected with computing device 440 before.

In some demonstrative aspects, display device 404 may be configured to establish a connection between the recognized BT peripheral device 404 and computing device 440, e.g., automatically, for example, based on detection that the recognized BT peripheral device 404 is within a predefined range (connection range) from the display device 402.

In some demonstrative aspects, display device 402 may be configured to establish a direct wireless connection with the peripheral BT device 404, for example, upon detection that the peripheral BT device 404 is in close proximity to the display device 402.

In some demonstrative aspects, the display device 402 may be configured to cause, e.g., trigger, connection between the peripheral BT device 404 and computing device 440, for example, such that computing device 440 may treat the peripheral BT device 404, for example, as a USB device.

In some demonstrative aspects, display device 402 may be configured to implement the BT-based proximity detection, e.g., as described above, for example, to provide a technical solution to support connection of BT peripheral devices, e.g., BT peripheral device 404, to computing devices, even when the computing devices do not have any wireless connectivity capabilities. For example, the BT radio of display device 402 may be utilized to provide the wireless connectivity to the BT peripheral device 404, while the display device 402 may be connected to the computing device 440 via a wired link 442.

In some demonstrative aspects, the controller of display device 402, e.g., controller 124 (FIG. 1), may be configured to handle situations in which two or more BT peripheral devices may be detected as approaching display device 402. For example, a user approaching display device 402 may carry two or more peripheral BT devices, e.g., a Smartphone and a headset.

In some demonstrative aspects, the controller of display device 402, e.g., controller 124 (FIG. 1), may be configured to select which of the two or more detected peripheral BT devices is to be connected to the computing device 440.

In some demonstrative aspects, the controller of display device 402, e.g., controller 124 (FIG. 1), may be configured to determine an order at which the two or more detected peripheral BT devices are to be connected to the computing device 440.

In some demonstrative aspects, the controller of display device 402, e.g., controller 124 (FIG. 1), may be configured to determine which detected peripheral BT device is to be connected to the computing device 440 and/or the order at which two or more detected peripheral BT devices are to be connected to the computing device 440, for example, based on one or more connection rules. For example, the connection rules may be defined by a user of the computing device 440. In one example, the user of computing device 440 may define a predefined connection priority to configure display device 402 to connect to the two or more peripheral BT devices.

In some demonstrative aspects, there may be a situation where the detected BT peripheral device 404 may already be connected to another BT device. For example, the detected BT peripheral device 404 may include a headset, which may already be connected to another BT device, e.g., a Smartphone carrier by the user of the headset.

In some demonstrative aspects, the controller of display device 402, e.g., controller 124 (FIG. 1), may be configured to determine whether the detected peripheral BT device is to be connected to the computing device 440, or to allow the detected peripheral BT device 404 to remain connected to the other BT device.

In some demonstrative aspects, the controller of display device 402, e.g., controller 124 (FIG. 1), may be configured to determine whether the detected peripheral BT device is to be connected to the computing device 440, for example, based on the connection rules defined by the user. For example, the user may define which device is to have priority in connecting to the peripheral BT device 404. In one example, the user may define which of the computing device 440 or the Smartphone is to have priority in connecting to the headset.

In some demonstrative aspects, there may be no need to prioritize connection to the detected peripheral BT device 404, for example, in case the detected peripheral BT device 404 has a capability of simultaneously connecting to multiple BT devices.

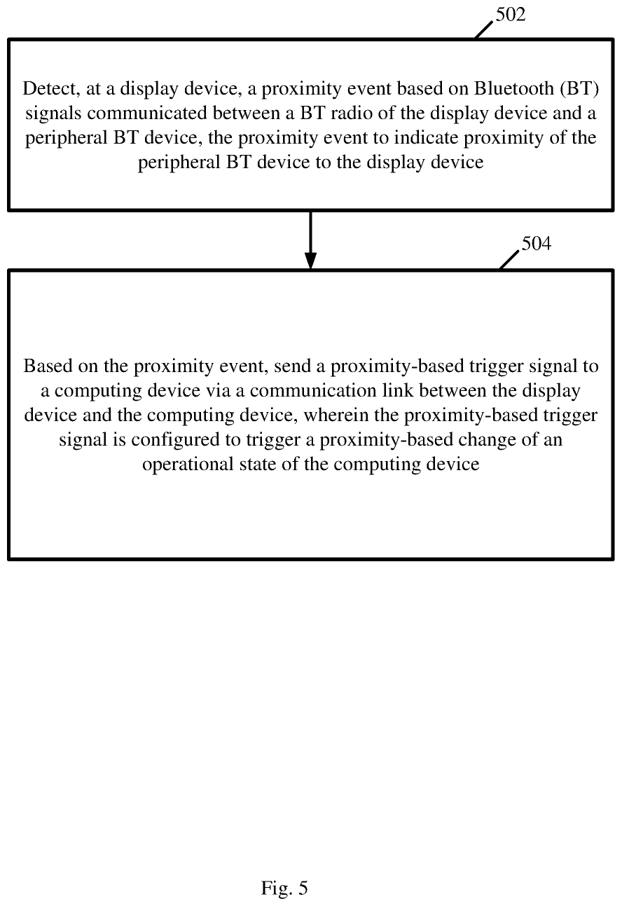

Reference is made to FIG. 5, which schematically illustrates a method of proximity detection, in accordance with some demonstrative aspects. For example, one or more operations of the method of FIG. 5, may be performed by one or more elements of a system, e.g., system 100 (FIG. 1), for example, a display device, e.g., display device 102 (FIG. 1), a controller, e.g., controller 124 (FIG. 1), and/or a message processor, e.g., message processor 128 (FIG. 1).

In some demonstrative aspects, as indicated at block 502, the method may include detecting at a display device a proximity event based on BT signals communicated between a BT radio of the display device and a peripheral BT device, the proximity event corresponding to, e.g., to indicate and/or represent, a proximity of the peripheral BT device and the display device. For example, controller 124 (FIG. 1) may be configured to detect the proximity event based on the BT signals 105 (FIG. 1) communicated between the BT radio 114 (FIG. 1) of the display device 102 (FIG. 1) and the peripheral BT device 104 (FIG. 1), e.g., as described above.

In some demonstrative aspects, as indicated at block 504, the method may include sending, e.g., based on the proximity event, a proximity-based trigger signal to a computing device via a communication link between the display device and the computing device. For example, the proximity-based trigger signal may be configured to cause, e.g., trigger, a proximity-based change of an operational state of the computing device. For example, controller 124 (FIG. 1) may be configured to, based on the proximity event, send the proximity-based trigger signal 145 (FIG. 1) to the computing device 140 (FIG. 1) via the communication link 142 (FIG. 1) between the display device 102 (FIG. 1) and the computing device 140 (FIG. 1). For example, the proximity-based trigger signal 145 (FIG. 1) may be configured to cause, e.g., trigger, the proximity-based change of the operational state of the computing device 140 (FIG. 1), e.g., as described above.

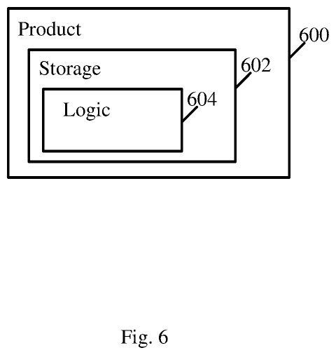

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at display device 102 (FIG. 1), controller 124 (FIG. 1), radio 114 (FIG. 1), and/or message processor 128 (FIG. 1); to cause display device 102 (FIG. 1), controller 124 (FIG. 1), radio 114 (FIG. 1), and/or message processor 128 (FIG. 1) to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 600 and/or machine-readable storage media 602 may include one or more types of computer-readable storage media capable of storing data, including volatile memory, non-volatile memory, removable or non-removable memory, erasable or non-erasable memory, writeable or re-writeable memory, and the like. For example, machine-readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a Solid State Drive (SSD), and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language.

### Examples

The following examples pertain to further aspects.

Example 1 includes an apparatus comprising logic and circuitry configured to cause a display device to detect a proximity event based on Bluetooth (BT) signals communicated between a BT radio of the display device and a peripheral BT device, the proximity event corresponding to a proximity of the peripheral BT device and the display device; and based on the proximity event, send a proximity-based trigger signal to a computing device via a communication link between the display device and the computing device, wherein the proximity-based trigger signal is configured to cause a proximity-based change of an operational state of the computing device.

Example 2 includes the subject matter of Example 1, and optionally, wherein the apparatus is configured to cause the display device to perform a BT proximity search to detect a potential BT device; determine whether the potential BT device is to be identified as a recognized BT device, which is designated for detection of the proximity event with respect to the computing device; and based on a determination the detected BT device is to be identified as the recognized BT device, detect the proximity event based on an estimated location of the recognized BT device relative to the display device, wherein the estimated location of the recognized BT device relative to the display device is based on BT signals communicated between the display device and the recognized BT device.

Example 3 includes the subject matter of Example 2, and optionally, wherein the apparatus is configured to cause the display device to perform the BT proximity search in an area in front of a screen of the display device.

Example 4 includes the subject matter of any one of Examples 1-3, and optionally, wherein the apparatus is configured to detect the proximity event based on a determination that the BT signals are communicated with the BT peripheral device in an area in front of a screen of the display device.

Example 5 includes the subject matter of any one of Examples 1-4, and optionally, wherein the proximity event comprises a user approach detection corresponding to a detected approach of a user to the display device.

Example 6 includes the subject matter of Example 5, and optionally, wherein the proximity-based trigger signal comprises a wakeup signal to cause the computing device to wake up from a power save state.

Example 7 includes the subject matter of Example 5 or 6, and optionally, wherein the proximity-based trigger signal comprises an unlock signal to cause unlocking of the computing device from a locked state to an unlocked state.

Example 8 includes the subject matter of any one of Examples 5-7, and optionally, wherein the proximity-based trigger signal comprises a peripheral-connection trigger signal to cause the computing device to connect with the peripheral BT device via the display device.

Example 9 includes the subject matter of any one of Examples 1-8, and optionally, wherein the proximity event comprises a user move-away detection corresponding to a detection of a user moving away from the display device.

Example 10 includes the subject matter of Example 9, and optionally, wherein the proximity-based trigger signal comprises a power save signal to cause the computing device to switch to a power save state.

Example 11 includes the subject matter of any one of Examples 9 or 10, and optionally, wherein the proximity-based trigger signal comprises a lock signal to cause the computing device to switch from an unlocked state to a locked state.

Example 12 includes the subject matter of any one of Examples 9-11, and optionally, wherein the proximity-based trigger signal comprises a peripheral-disconnection trigger signal to cause the computing device to disconnect from the peripheral BT device.

Example 13 includes the subject matter of any one of Examples 1-12, and optionally, wherein the apparatus is configured to cause the display device to detect the proximity event according to a High-Accuracy Distance Measurement (HADM) based on the BT signals.

Example 14 includes the subject matter of any one of Examples 1-13, and optionally, wherein the apparatus is configured to cause the display device to detect the proximity event according to a Carrier Sensing (CS) measurement based on the BT signals.

Example 15 includes the subject matter of any one of Examples 1-14, and optionally, wherein the apparatus is configured to cause the display device to detect the proximity event according to at least one of an Angle of Arrival (AoA) measurement or an Angle of Departure (AoD) measurement based on the BT signals.

Example 16 includes the subject matter of any one of Examples 1-15, and optionally, wherein the proximity-based change of the operational state of the computing device comprises at least one of a change of a power state of the computing device, a change of a locking state of the computing device, or a change of a peripheral-connection state of a connection between the computing device and the peripheral BT device.

Example 17 includes the subject matter of any one of Examples 1-16, and optionally, wherein the computing device comprises a desktop computer or a laptop computer.

Example 18 includes the subject matter of any one of Examples 1-17, and optionally, comprising the BT radio.

Example 19 includes the subject matter of Example 18, and optionally, comprising the display device, the display device comprising a screen, the BT radio, and one or more antennas connected to the BT radio.

Example 20 comprises a display device comprising the apparatus of any one of Examples 1-19.

Example 21 comprises an apparatus comprising means for executing any of the described operations of Examples 1-19.

Example 22 comprises a product comprising one or more tangible computer-readable non-transitory storage media comprising computer-executable instructions operable to, when executed by at least one processor, enable the at least one processor to cause a device to perform any of the described operations of Examples 1-19.

Example 23 comprises an apparatus comprising: a memory interface; and processing circuitry configured to: perform any of the described operations of Examples 1-19.

Example 24 comprises a method comprising any of the described operations of Examples 1-19.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a display device to:
detect a proximity event based on Bluetooth (BT) signals communicated between a BT radio of the display device and a peripheral BT device, the proximity event corresponding to a proximity of the peripheral BT device and the display device; and
based on the proximity event, send a proximity-based trigger signal to a computing device via a communication link between the display device and the computing device, wherein the proximity-based trigger signal is configured to cause a proximity-based change of an operational state of the computing device.

2. The apparatus of claim 1 configured to cause the display device to:
perform a BT proximity search to detect a potential BT device;
determine whether the potential BT device is to be identified as a recognized BT device, which is designated for detection of the proximity event with respect to the computing device; and
based on a determination the detected BT device is to be identified as the recognized BT device, detect the proximity event based on an estimated location of the recognized BT device relative to the display device, wherein the estimated location of the recognized BT device relative to the display device is based on BT signals communicated between the display device and the recognized BT device.

3. The apparatus of claim 2 configured to cause the display device to perform the BT proximity search in an area in front of a screen of the display device.

4. The apparatus of claim 1 configured to detect the proximity event based on a determination that the BT signals are communicated in an area in front of a screen of the display device.

5. The apparatus of claim 1, wherein the proximity event comprises a user approach detection corresponding to a detected approach of a user to the display device.

6. The apparatus of claim 5, wherein the proximity-based trigger signal comprises a wakeup signal to cause the computing device to wake up from a power save state.

7. The apparatus of claim 5, wherein the proximity-based trigger signal comprises an unlock signal to cause unlocking of the computing device from a locked state to an unlocked state.

8. The apparatus of claim 5, wherein the proximity-based trigger signal comprises a peripheral-connection trigger signal to cause the computing device to connect with the peripheral BT device via the display device.

9. The apparatus of claim 1, wherein the proximity event comprises a user move-away detection to corresponding to a detection of a user moving away from the display device.

10. The apparatus of claim 9, wherein the proximity-based trigger signal comprises a power save signal to cause the computing device to switch to a power save state.

11. The apparatus of claim 9, wherein the proximity-based trigger signal comprises a lock signal to cause the computing device to switch from an unlocked state to a locked state.

12. The apparatus of claim 9, wherein the proximity-based trigger signal comprises a peripheral-disconnection trigger signal to cause the computing device to disconnect from the peripheral BT device.

13. The apparatus of claim 1 configured to cause the display device to detect the proximity event according to a High-Accuracy Distance Measurement (HADM) based on the BT signals.

14. The apparatus of claim 1 configured to cause the display device to detect the proximity event according to a Carrier Sensing (CS) measurement based on the BT signals.

15. The apparatus of claim 1 configured to cause the display device to detect the proximity event according to at least one of an Angle of Arrival (AoA) measurement or an Angle of Departure (AoD) measurement based on the BT signals.

16. The apparatus of claim 1, wherein the proximity-based change of the operational state of the computing device comprises at least one of a change of a power state of the computing device, a change of a locking state of the computing device, or a change of a peripheral-connection state of a connection between the computing device and the peripheral BT device.

17. The apparatus of claim 1, wherein the computing device comprises a desktop computer or a laptop computer.

18. The apparatus of claim 1 comprising the BT radio.

19. A display device comprising:
a screen;
a communication interface to communicate with a computing device via a communication link between the display device and the computing device;
a Bluetooth (BT) radio; and
a controller configured to cause the display device to detect a proximity event based on BT signals communicated between the BT radio of the display device and a peripheral BT device, the proximity event corresponding to a proximity of the peripheral BT device and the display device; and, based on the proximity event, to send a proximity-based trigger signal to the computing device via the communication link between the display device and the computing device, wherein the proximity-based trigger signal is configured to cause a proximity-based change of an operational state of the computing device.

20. The display device of claim 19, wherein the controller is configured to cause the display device to:
perform a BT proximity search to detect a potential BT device;
determine whether the potential BT device is to be identified as a recognized BT device, which is designated for detection of the proximity event with respect to the computing device; and
based on a determination the detected BT device is to be identified as the recognized BT device, detect the proximity event based on an estimated location of the recognized BT device relative to the display device, wherein the estimated location of the recognized BT device relative to the display device is based on BT signals communicated between the display device and the recognized BT device.

21. A product comprising one or more tangible computer-readable non-transitory storage media comprising instructions operable to, when executed by at least one processor, enable the at least one processor to cause a display device to:
detect a proximity event based on Bluetooth (BT) signals communicated between a BT radio of the display device and a peripheral BT device, the proximity event corresponding to a proximity of the peripheral BT device and the display device; and
based on the proximity event, send a proximity-based trigger signal to a computing device via a communication link between the display device and the computing device, wherein the proximity-based trigger signal is configured to cause a proximity-based change of an operational state of the computing device.

22. The product of claim 21, wherein the instructions, when executed, cause the display device to:
perform a BT proximity search to detect a potential BT device;
determine whether the potential BT device is to be identified as a recognized BT device, which is designated for detection of the proximity event with respect to the computing device; and
based on a determination the detected BT device is to be identified as the recognized BT device, detect the proximity event based on an estimated location of the recognized BT device relative to the display device, wherein the estimated location of the recognized BT device relative to the display device is based on BT signals communicated between the display device and the recognized BT device.

23. The product of claim 21, wherein the instructions, when executed, cause the display device to detect the proximity event according to a High-Accuracy Distance Measurement (HADM) based on the BT signals.

24. An apparatus for a display device, the apparatus comprising:
means for detecting at the display device a proximity event based on Bluetooth (BT) signals communicated between a BT radio of the display device and a peripheral BT device, the proximity event corresponding to a proximity of the peripheral BT device and the display device; and
means for, based on the proximity event, causing the display device to send a proximity-based trigger signal to a computing device via a communication link between the display device and the computing device, wherein the proximity-based trigger signal is configured to cause a proximity-based change of an operational state of the computing device.

25. The apparatus of claim 24, wherein the proximity-based change of the operational state of the computing device comprises at least one of a change of a power state of the computing device, a change of a locking state of the computing device, or a change of a peripheral-connection state of a connection between the computing device and the peripheral BT device.
